(19) United States
(12) Patent Application Publication
(10) Pub. No.: US 2018/0019069 A1
(43) Pub. Date: Jan. 18, 2018

(54) Production of Graphene-Based Supercapacitor Electrode from Coke or Coal Using Direct Ultrasonication

(71) Applicant: Nanotek Instruments, Inc., Dayton, OH (US)

(72) Inventors: Aruna Zhamu, Springboro, OH (US); Bor Z. Jang, Centerville, OH (US)

(73) Assignee: Nanotek Instruments, Inc., Dayton, OH (US)

(21) Appl. No.: 15/211,269

(22) Filed: Jul. 15, 2016

(51) Int. Cl. H01G 11/34; H01G 11/42; H01G 11/44; H01G 11/86

(52) U.S. Cl. CPC H01G 11/34; H01G 11/86; H01G 11/42; H01G 11/44

(57) ABSTRACT

Provided is a method of producing graphene-based supercapacitor electrode from a supply of coke or coal powder. The method comprises: (a) dispersing particles of the coke or coal powder in a liquid medium containing therein an optional surfactant or dispersing agent to produce a suspension or slurry, wherein the coke or coal powder is selected from petroleum coke, coal-derived coke, meso-phase coke, synthetic coke, leonardite, anthracite, lignite coal, bituminous coal, or natural coal mineral powder, or a combination thereof; (b) exposing the suspension or slurry to ultrasonication at an energy level for a sufficient length of time to produce a graphene suspension having isolated graphene sheets dispersed in the liquid medium; and (c) shaping and drying the graphene suspension into the supercapacitor electrode in a film, filament, rod, or tube form that is porous and has a specific surface area greater than 200 m²/g.

### FIELD OF THE INVENTION

The present invention relates to a process for producing a graphene-based supercapacitor electrode directly from natural coal or coal derivatives (e.g. needle coke) using direct ultrasonication.

### BACKGROUND

Electrochemical capacitors (ECs), also known as ultracapacitors or supercapacitors, are being considered for uses in hybrid electric vehicles (EVs) where they can supplement a battery used in an electric car to provide bursts of power needed for rapid acceleration, the biggest technical hurdle to making battery-powered cars commercially viable. A battery would still be used for cruising, but supercapacitors (with their ability to release energy much more quickly than batteries) would kick in whenever the car needs to accelerate for merging, passing, emergency maneuvers, and hill climbing. The EC must also store sufficient energy to provide an acceptable driving range. To be cost-, volume-, and weight-effective compared to additional battery capacity they must combine adequate energy densities (volumetric and gravimetric) and power densities (volumetric and gravimetric) with long cycle life, and meet cost targets as well.

ECs are also gaining acceptance in the electronics industry as system designers become familiar with their attributes and benefits. ECs were originally developed to provide large bursts of driving energy for orbital lasers. In complementary metal oxide semiconductor (CMOS) memory backup applications, for instance, a one-Farad EC having a volume of only one-half cubic inch can replace nickel-cadmium or lithium batteries and provide backup power for months. For a given applied voltage, the stored energy in an EC associated with a given charge is half that storable in a corresponding battery system for passage of the same charge. Nevertheless, ECs are extremely attractive power sources. Compared with batteries, they require no maintenance, offer much higher cycle-life, require a very simple charging circuit, experience no “memory effect,” and are generally much safer. Physical rather than chemical energy storage is the key reason for their safe operation and extraordinarily high cycle-life. Perhaps most importantly, capacitors offer higher power density than batteries.

The high volumetric capacitance density of an EC relative to conventional capacitors (10 to 100 times greater than conventional capacitors) derives from using porous electrodes to create a large effective “plate area” and from storing energy in the diffuse double layer. This double layer, created naturally at a solid-electrolyte interface when voltage is imposed, has a thickness of only about 1 nm, thus forming an extremely small effective “plate separation.” Such a supercapacitor is commonly referred to as an electric double layer capacitor (EDLC). The double layer capacitor is based on a high surface area electrode material, such as activated carbon, immersed in a liquid electrolyte. A polarized double layer is formed at electrode-electrolyte interfaces providing high capacitance. This implies that the specific capacitance of a supercapacitor is directly proportional to the specific surface area of the electrode material. This surface area must be accessible by electrolyte and the resulting interfacial zones must be sufficiently large to accommodate the so-called electric double-layer charges.

In some ECs, stored energy is further augmented by pseudo-capacitance effects, occurring again at the solid-electrolyte interface due to electrochemical phenomena such as the redox charge transfer. Such a supercapacitor is commonly referred to as a pseudo-capacitor or redox supercapacitor. A third type of supercapacitor is a lithium-ion capacitor that contains a pre-lithiated graphite anode, an EDLC cathode (e.g. typically based on activated carbon particles), and a lithium salt electrolyte.

However, there are several serious technical issues associated with current state-of-the-art supercapacitors:
(1) Experience with supercapacitors based on activated carbon electrodes shows that the experimentally measured capacitance is always much lower than the geometrical capacitance calculated from the measured surface area and the width of the dipole layer. For very high surface area activated carbons, typically only about 20-40 percent of the “theoretical” capacitance was observed. This disappointing performance is related to the presence of micro-pores (<2 nm, mostly <1 nm) and ascribed to inaccessibility of some pores by the electrolyte, wetting deficiencies, and/or the inability of a double layer to form successfully in pores in which the oppositely charged surfaces are less than about 1-2 nm apart. In activated carbons, depending on the source of the carbon and the heat treatment temperature, a surprising amount of surfaces can be in the form of such micro-pores that are not accessible to liquid electrolyte.
(2) Despite the high gravimetric capacitances at the electrode level (based on active material weights alone) as frequently claimed in open literature and patent documents, these electrodes unfortunately fail to provide energy storage devices with high capacities at the supercapacitor cell or pack level (based on the total cell weight or pack weight). This is due to the notion that, in these reports, the actual mass loadings of the electrodes and the apparent densities for the active materials are too low. In most cases, the active material mass loadings of the electrodes (areal density) is significantly lower than 10 mg/cm² (areal density=the amount of active materials per electrode cross-sectional area along the electrode thickness direction) and the apparent volume density or tap density of the active material is typically less than 0.75 g/cm³ (more typically less than 0.5 g/cm³ and most typically less than 0.3 g/cm³) even for relatively large particles of activated carbon.
   The low mass loading is primarily due to the inability to obtain thicker graphene-based electrodes (thicker than 100 μm) using the conventional slurry coating procedure. This is not a trivial task as one might think, and in reality the electrode thickness is not a design parameter that can be arbitrarily and freely varied for the purpose of optimizing the cell performance. Contrarily, thicker electrodes tend to become extremely brittle or of poor structural integrity and would also require the use of large amounts of binder resin. These problems are particularly acute for graphene material-based electrodes. It has not been previously possible to produce graphene-based electrodes that are thicker than 100 μm and remain highly porous with pores remaining fully accessible to liquid electrolyte. The low areal densities and low volume densities (related to thin electrodes and poor packing density) result in relatively low volumetric capacitances and low volumetric energy density of the supercapacitor cells.
   With the growing demand for more compact and portable energy storage systems, there is keen interest to increase the utilization of the volume of the energy storage devices. Novel electrode materials and designs that enable high volumetric capacitances and high mass loadings are essential to achieving improved cell volumetric capacitances and energy densities.
(3) During the past decade, much work has been conducted to develop electrode materials with increased volumetric capacitances utilizing porous carbon-based materials, such as graphene, carbon nanotube-based composites, porous graphite oxide, and porous meso carbon. Although these experimental supercapacitors featuring such electrode materials can be charged and discharged at high rates and also exhibit large volumetric electrode capacitances (50 to 150 F/cm³ in most cases, based on the electrode volume), their typical active mass loading of <1 mg/cm², tap density of <0.2 g/cm³, and electrode thicknesses of up to tens of micrometers (<<100 μm) are still significantly lower than those used in most commercially available electrochemical capacitors (i.e. 10 mg/cm², 100-200 μm), which results in energy storage devices with relatively low areal and volumetric capacitances and low volumetric energy densities.
(4) For graphene-based supercapacitors, there are additional problems that remain to be solved, explained below:

Graphene exhibits exceptionally high thermal conductivity, high electrical conductivity, high strength, and exceptionally high specific surface area. A single graphene sheet provides a specific external surface area of approximately 2,675 m²/g (that is accessible by liquid electrolyte), as opposed to the exterior surface area of approximately 1,300 m²/g provided by a corresponding single-wall CNT (interior surface not accessible by electrolyte). The electrical conductivity of graphene is slightly higher than that of CNTs.

The instant applicants (A. Zhamu and B. Z. Jang) and their colleagues were the first to investigate graphene- and other nano graphite-based nano materials for supercapacitor application [Please see Refs. 1-5 below; the 1^{st} patent application was submitted in 2006 and issued in 2009]. After 2008, researchers began to realize the significance of graphene materials for supercapacitor applications.

### LIST OF REFERENCES

1. Lulu Song, A. Zhamu, Jiusheng Guo, and B. Z. Jang “Nano-scaled Graphene Plate Nanocomposites for Supercapacitor Electrodes” U.S. Pat. No. 7,623,340 (Nov. 24, 2009).
2. Aruna Zhamu and Bor Z. Jang, “Process for Producing Nano-scaled Graphene Platelet Nanocomposite Electrodes for Supercapacitors,” U.S. patent application Ser. No. 11/906,786 (Oct. 4, 2007).
3. Aruna Zhamu and Bor Z. Jang, “Graphite-Carbon Composite Electrodes for Supercapacitors” U.S. patent application Ser. No. 11/895,657 (Aug. 27, 2007).
4. Aruna Zhamu and Bor Z. Jang, “Method of Producing Graphite-Carbon Composite Electrodes for Supercapacitors” U.S. patent application Ser. No. 11/895,588 (Aug. 27, 2007).
5. Aruna Zhamu and Bor Z. Jang, “Graphene Nanocomposites for Electrochemical cell Electrodes,” U.S. patent application Ser. No. 12/220,651 (Jul. 28, 2008).

However, individual nano graphene sheets have a great tendency to re-stack themselves, effectively reducing the specific surface areas that are accessible by the electrolyte in a supercapacitor electrode. The significance of this graphene sheet overlap issue may be illustrated as follows: For a nano graphene platelet with dimensions of l (length)×w (width)×t (thickness) and density ρ, the estimated surface area per unit mass is S/m=(2/ρ) (1/l+1/w+1/t). With ρ≅2.2 g/cm³, l=100 nm, w=100 nm, and t=0.34 nm (single layer), we have an impressive S/m value of 2,675 m²/g, which is much greater than that of most commercially available carbon black or activated carbon materials used in the state-of-the-art supercapacitor. If two single-layer graphene sheets stack to form a double-layer graphene, the specific surface area is reduced to 1,345 m²/g. For a three-layer graphene, t=1 nm, we have S/m=906 m²/g. If more layers are stacked together, the specific surface area would be further significantly reduced.

These calculations suggest that it is critically important to find a way to prevent individual graphene sheets from re-stacking and, even if they partially re-stack, the resulting multi-layer structure would still have inter-layer pores of adequate sizes. These pores must be sufficiently large to allow for accessibility by the electrolyte and to enable the formation of electric double-layer charges, which presumably require a pore size of at least 1-2 nm. However, these pores or inter-graphene spacings must also be sufficiently small to ensure a large tap density (hence, large capacitance per unit volume or large volumetric energy density). Unfortunately, the typical tap density of graphene-based electrode produced by the conventional process is less than 0.3 g/cm³, and most typically <<0.2 g/cm³. To a great extent, the requirement to have large pore sizes and high porosity level and the requirement to have a high tap density are considered mutually exclusive in supercapacitors.

Another major technical barrier to using graphene sheets as a supercapacitor electrode active material is the challenge of forming a thick active material layer onto the surface of a solid current collector (e.g. Al foil) using the conventional graphene-solvent slurry coating process. In such an electrode, the graphene electrode typically requires a large amount of a binder resin (hence, significantly reduced active material proportion vs. non-active or overhead materials/components). In addition, any graphene electrode prepared in this manner that is thicker than 50 μm is brittle and weak. There has been no effective solution to these problems.

Therefore, there is clear and urgent need for supercapacitors that have high active material mass loading (high areal density), active materials with a high apparent density (high tap density), high electrode thickness, high volumetric capacitance, and high volumetric energy density. For graphene-based electrodes, one must also overcome problems such as re-stacking of graphene sheets, the demand for large proportion of a binder resin, and difficulty in producing thick graphene electrode layers.

A single-layer graphene sheet is composed of carbon atoms occupying a two-dimensional hexagonal lattice. Multi-layer graphene is a platelet composed of more than one graphene plane. Individual single-layer graphene sheets and multi-layer graphene platelets are herein collectively called nano graphene platelets (NGPs) or graphene materials. NGPs include pristine graphene (essentially 99% of carbon atoms), slightly oxidized graphene (<5% by weight of oxygen), graphene oxide (≧5% by weight of oxygen), slightly fluorinated graphene (<5% by weight of fluorine), graphene fluoride ((≧5% by weight of fluorine), other halogenated graphene, and chemically functionalized graphene.

NGPs have been found to have a range of unusual physical, chemical, and mechanical properties. For instance, graphene was found to exhibit the highest intrinsic strength and highest thermal conductivity of all existing materials. Although practical electronic device applications for graphene (e.g., replacing Si as a backbone in a transistor) are not envisioned to occur within the next 5-10 years, its application as a nano filler in a composite material and an electrode material in energy storage devices is imminent. The availability of graphene sheets in large quantities is essential to the success in exploiting composite, energy, and other applications for graphene.

Our research group was among the first to discover graphene [B. Z. Jang and W. C. Huang, “Nano-scaled Graphene Plates,” U.S. patent application Ser. No. 10/274,473, submitted on Oct. 21, 2002; now U.S. Pat. No. 7,071,258 (Jul. 4, 2006)]. The processes for producing NGPs and NGP nanocomposites were reviewed by us [Bor Z. Jang and A. Zhamu, “Processing of Nano Graphene Platelets (NGPs) and NGP Nanocomposites: A Review,” J. Materials Sci. 43 (2008) 5092-5101]. Four main prior-art approaches have been followed to produce NGPs. Their advantages and shortcomings are briefly summarized as follows:

### Approach 1: Chemical Formation and Reduction of Graphite Oxide (GO) Platelets

The first approach entails treating natural graphite powder with an intercalant and an oxidant (e.g., concentrated sulfuric acid and nitric acid, respectively) to obtain a graphite intercalation compound (GIC) or, actually, graphite oxide (GO). [William S. Hummers, Jr., et al., Preparation of Graphitic Oxide, Journal of the American Chemical Society, 1958, p. 1339.] Prior to intercalation or oxidation, graphite has an inter-graphene plane spacing of approximately 0.335 nm (L_{d}=½d₀₀₂=0.335 nm). With an intercalation and oxidation treatment, the inter-graphene spacing is increased to a value typically greater than 0.6 nm. This is the first expansion stage experienced by the graphite material during this chemical route. The obtained GIC or GO is then subjected to further expansion (often referred to as exfoliation) using either a thermal shock exposure or a solution-based, ultrasonication-assisted graphene layer exfoliation approach.

In the thermal shock exposure approach, the GIC or GO is exposed to a high temperature (typically 800-1,050° C.) for a short period of time (typically 15 to 60 seconds) to exfoliate or expand the GIC or GO for the formation of exfoliated or further expanded graphite, which is typically in the form of a “graphite worm” composed of graphite flakes that are still interconnected with one another. This thermal shock procedure can produce some separated graphite flakes or graphene sheets, but normally the majority of graphite flakes remain interconnected. Typically, the exfoliated graphite or graphite worm is then subjected to a flake separation treatment using air milling, mechanical shearing, or ultrasonication in water. Hence, approach 1 basically entails three distinct procedures: first expansion (oxidation or intercalation), further expansion (or “exfoliation”), and separation.

In the solution-based separation approach, the expanded (i.e. oxidized and/or intercalated graphite) or exfoliated GO powder is dispersed in water or aqueous alcohol solution, which is subjected to ultrasonication. It is important to note that in these processes, ultrasonification is used after intercalation and oxidation of graphite (i.e., after first expansion) and typically after thermal shock exposure of the resulting GIC or GO (after second expansion). Alternatively, the GO powder dispersed in water is subjected to an ion exchange or lengthy purification procedure in such a manner that the repulsive forces between ions residing in the inter-planar spaces overcome the inter-graphene van der Waals forces, resulting in graphene layer separations.

There are several major problems associated with this conventional chemical production process:
(1) The process requires the use of large quantities of several undesirable chemicals, such as sulfuric acid, nitric acid, and potassium permanganate or sodium chlorate.
(2) The chemical treatment process requires a long intercalation and oxidation time, typically 5 hours to five days.
(3) Strong acids consume a significant amount of graphite during this long intercalation or oxidation process by “eating their way into the graphite” (converting graphite into carbon dioxide, which is lost in the process). It is not unusual to lose 20-50% by weight of the graphite material immersed in strong acids and oxidizers.
(4) Both heat- and solution-induced exfoliation approaches require a very tedious washing and purification step. For instance, typically 2.5 kg of water is used to wash and recover 1 gram of GIC, producing huge quantities of waste water that need to be properly treated.
(5) In both the heat- and solution-induced exfoliation approaches, the resulting products are GO platelets that must undergo a further chemical reduction treatment to reduce the oxygen content. Typically even after reduction, the electrical conductivity of GO platelets remains much lower than that of pristine graphene. Furthermore, the reduction procedure often involves the utilization of toxic chemicals, such as hydrazine.
(6) Furthermore, the quantity of intercalation solution retained on the flakes after draining may range from 20 to 150 parts of solution by weight per 100 parts by weight of graphite flakes (pph) and more typically about 50 to 120 pph.
(7) During the high-temperature exfoliation, the residual intercalate species (e.g. sulfuric acid and nitric acid) retained by the flakes decompose to produce various species of sulfuric and nitrous compounds (e.g., NOₓ and SOₓ), which are undesirable. The effluents require expensive remediation procedures in order not to have an adverse environmental impact.
   The present invention was made to overcome the limitations outlined above.

### Approach 2: Direct Formation of Pristine Nano Graphene Sheets

In 2002, our research team succeeded in isolating single-layer and multi-layer graphene sheets from partially carbonized or graphitized polymeric carbons, which were obtained from a polymer or pitch precursor [B. Z. Jang and W. C. Huang, “Nano-scaled Graphene Plates,” U.S. patent application Ser. No. 10/274,473, submitted on Oct. 21, 2002; now U.S. Pat. No. 7,071,258 (Jul. 4, 2006)]. Mack, et al [“Chemical manufacture of nanostructured materials” U.S. Pat. No. 6,872,330 (Mar. 29, 2005)] developed a process that involved intercalating natural graphite with potassium metal melt and contacting the resulting K-intercalated graphite with alcohol, producing violently exfoliated graphite containing NGPs. The process must be carefully conducted in a vacuum or an extremely dry glove box environment since pure alkali metals, such as potassium and sodium, are extremely sensitive to moisture and pose an explosion danger. This process is not amenable to the mass production of NGPs. The present invention was made to overcome the limitations outlined above.

### Approach 3: Epitaxial Growth and Chemical Vapor Deposition of Nano Graphene Sheets on Inorganic Crystal Surfaces

Small-scale production of ultra-thin graphene sheets on a substrate can be obtained by thermal decomposition-based epitaxial growth and a laser desorption-ionization technique. [Walt A. DeHeer, Claire Berger, Phillip N. First, “Patterned thin film graphite devices and method for making same” U.S. Pat. No. 7,327,000 B2 (Jun. 12, 2003)] Epitaxial films of graphite with only one or a few atomic layers are of technological and scientific significance due to their peculiar characteristics and great potential as a device substrate. However, these processes are not suitable for mass production of isolated graphene sheets for composite materials and energy storage applications.

Approach 4: The Bottom-Up Approach (Synthesis of Graphene from Small Molecules)

Yang, et al. [“Two-dimensional Graphene Nano-ribbons,” J. Am. Chem. Soc. 130 (2008) 4216-17] synthesized nano graphene sheets with lengths of up to 12 nm using a method that began with Suzuki-Miyaura coupling of 1,4-diiodo-2,3,5,6-tetraphenyl-benzene with 4-bromophenylboronic acid. The resulting hexaphenylbenzene derivative was further derivatized and ring-fused into small graphene sheets. This is a slow process that thus far has produced very small graphene sheets.

Hence, an urgent need exists to have a graphene production process that requires a reduced amount of undesirable chemicals (or elimination of these chemicals all together), shortened process time, less energy consumption, lower degree of graphene oxidation, reduced or eliminated effluents of undesirable chemical species into the drainage (e.g., sulfuric acid) or into the air (e.g., SO₂ and NO₂). The process should be able to produce more pristine (less oxidized and less damaged), more electrically conductive, and larger/wider graphene sheets.

Furthermore, most of the prior art processes for graphene production begin with the use of highly purified natural graphite as the starting material. The purification of graphite ore involves the use of large amounts of undesirable chemicals. Clearly, a need exists to have a more cost-effective process that produces graphene sheets (particularly single-layer graphene and few-layer graphene sheets) directly from coal or coal derivatives and readily converts the graphene sheets into a porous supercapacitor electrode. Such a process not only avoids the environment-polluting graphite ore purification procedures but also makes it possible to have low-cost graphene available. As of today, the graphene, as an industry, has yet to emerge mainly due to the extremely high graphene costs that have thus far prohibited graphene-based products from being widely accepted in the marketplace.

A further object of the present invention is a process for producing graphene-based supercapacitor electrode that has an active material mass loading higher than 10 mg/cm², preferably higher than 20 mg/cm², and more preferably higher than 30 mg/cm².

### SUMMARY OF THE INVENTION

The present invention provides a process for producing a graphene-based supercapacitor electrode from a supply of coke or coal powder containing therein domains of hexagonal carbon atoms and/or hexagonal carbon atomic interlayers with an interlayer spacing (inter-graphene plane spacing). The process comprises:
(a) dispersing particles of coke or coal powder in a liquid medium containing therein an optional surfactant or dispersing agent to produce a suspension or slurry, wherein the coke or coal powder is selected from petroleum coke, coal-derived coke, meso-phase coke, synthetic coke, leonardite, anthracite, lignite coal, bituminous coal, or natural coal mineral powder, or a combination thereof;
(b) exposing the suspension or slurry to ultrasonication at an energy level for a sufficient length of time to produce a graphene suspension containing isolated graphene sheets dispersed in the liquid medium; and
(c) shaping and drying the graphene suspension to form the supercapacitor electrode that is porous and has a specific surface area greater than 200 m²/g.

Preferably, these coke or coal powder particles have never been previously intercalated or oxidized prior to step (a). The supercapacitor electrode is preferably in a sheet, film, filament, rod, or tube form.

In some embodiments, the liquid medium comprises water, an organic solvent, alcohol, a monomer, an oligomer, or a combination thereof. In some preferred embodiments, the liquid medium further comprises a monomer or an oligomer dispersed in the liquid medium and, in step (b), the ultrasonication also induces polymerization of the monomer or oligomer to form a polymer (in addition to producing isolated graphene sheets, which are typically single-layer graphene or few-layer graphene). Preferably, the process further comprises a step of thermally converting the polymer into carbon or graphite that acts as a binder to bond the isolated graphene sheets together to form the supercapacitor electrode that has a specific surface area greater than 500 m²/g, preferably greater than 1,000 m²/g, and more preferably greater than 2,000 m²/g.

In some embodiments, the liquid medium may further comprise a polymer dissolved or dispersed in the liquid medium and the isolated graphene sheets are mixed with the polymer to form a composite composition. Preferably, the process further comprises a step of thermally converting the polymer into carbon or graphite that acts as a binder to bond the isolated graphene sheets together to form the supercapacitor electrode that has a specific surface area greater than 500 m²/g, preferably greater than 1,000 m²/g, and further preferably greater than 1,500 m²/g, and most preferably greater than 2,000 m²/g.

In some embodiments, the surfactant or dispersing agent is selected from the group consisting of anionic surfactants, nonionic surfactants, cationic surfactants, amphoteric surfactants, silicone surfactants, fluoro-surfactants, polymeric surfactants, sodium hexametaphosphate, sodium lignosulphonate, poly (sodium 4-styrene sulfonate), sodium dodecylsulfate, sodium sulfate, sodium phosphate, sodium sulfonate, and combinations thereof.

In some preferred embodiments, the surfactant or dispersing agent is selected from melamine, ammonium sulfate, sodium dodecyl sulfate, sodium (ethylenediamine), tetraalkyammonium, ammonia, carbamide, hexamethylenetetramine, organic amine, pyrene, 1-pyrenecarboxylic acid, 1-pyrenebutyric acid, 1-pyrenamine, poly(sodium-4-styrene sulfonate), or a combination thereof.

In the presently invented process, a desired amount of foaming agent may be added into the graphene suspension and step (c) may include depositing graphene suspension onto a surface of a solid substrate to form a wet graphene film under the influence of a shear stress or compressive stress to align the graphene sheets parallel to the substrate surface, and wherein the wet film is dried to form a porous dry graphene film. The graphene suspension may be deposited onto the surface using a procedure of casting, coating, spraying, printing, or a combination thereof. The graphene suspension may be shaped into a filament or rod form using a fiber-spinning or extrusion procedure.

In some embodiments, the wet graphene film or dry graphene film is subjected to a heat treatment at a temperature from 100° C. to 3,200° C.

The step of shaping and drying said graphene suspension may comprise dispensing the suspension onto a surface or two surfaces of a current collector to form the desired supercapacitor electrode in a film form having a thickness from 1 μm to 1,000 μm.

In certain desirable embodiments, the step of shaping and drying the graphene suspension comprises dispensing and heat treating the suspension to form a layer of graphene foam having a thickness from 1 μm to 1,000 μm. Alternatively, the step of shaping and drying the graphene suspension comprises freeze-drying the suspension to form a graphene foam electrode.

### BRIEF DESCRIPTION OF THE DRAWINGS

FIG. 1 A flow chart showing an embodiment of the presently invented method of producing graphene-based electrode.

FIG. 2 Schematic drawing of an apparatus for ultrasonication of coal/coke slurry to produce suspension containing isolated graphene sheets dispersed in a liquid medium.

FIG. 3 Electrode specific capacitance of supercapacitors using an organic electrolyte (acetonitrile) and graphene produced from coal and graphite, respectively.

FIG. 4 Ragone plots (gravimetric and volumetric power density vs. gravimetric and volumetric energy density) of two sets of symmetric supercapacitor (EDLC) cells: one containing coke-derived graphene prepared by the instant process and the other natural graphite-derived graphene.

### DETAILED DESCRIPTION OF PREFERRED EMBODIMENTS

Carbon materials can assume an essentially amorphous structure (glassy carbon), a highly organized crystal (graphite), or a whole range of intermediate structures that are characterized in that various proportions and sizes of graphite crystallites and defects are dispersed in an amorphous matrix. Typically, a graphite crystallite is composed of a number of graphene sheets or basal planes that are bonded together through van der Waals forces in the c-axis direction, the direction perpendicular to the basal plane. These graphite crystallites are typically micron- or nanometer-sized. The graphite crystallites are dispersed in or connected by crystal defects or an amorphous phase in a graphite particle, which can be a graphite flake, carbon/graphite fiber segment, carbon/graphite whisker, or carbon/graphite nano-fiber. In the case of a carbon or graphite fiber segment, the graphene plates may be a part of a characteristic “turbostratic structure.”

Basically, a graphite material is composed of many graphene planes (hexagonal carbon atomic interlayers) stacked together having inter-planar spacing. These graphene planes can be exfoliated and separated to obtain isolated graphene sheets that can each contain one graphene plane or several graphene planes of hexagonal carbon atoms. Further, natural graphite refers to a graphite material that is produced from purification of graphite mineral (mined graphite ore or graphite rock) typically by a series of flotation and acid treatments. Particles of natural graphite are then subjected to intercalation/oxidation, expansion/exfoliation, and separation/isolation treatments as discussed in the Background section.

The instant invention obviates the need to go through the graphite purification procedures that otherwise generate great amounts of polluting chemicals. In fact, the instant invention avoids the use of natural graphite all together as a starting material for the production of graphene sheets and graphene-based supercapacitor electrodes. Instead, we begin with coal or its derivatives (including coke, particularly needle coke). No undesirable chemicals, such as concentrated sulfuric acid, nitric acid, and potassium permanganate, are used in the presently invented method.

One preferred specific embodiment of the present invention is a direct ultrasonication-based method of producing isolated graphene sheets, also called nano graphene platelets (NGPs), directly from coal powder without purification and without pre-intercalation or pre-oxidation. These graphene sheets are then readily made into supercapacitor electrodes using casting, printing, coating, foaming, etc. We have surprisingly discovered that powder of coal (e.g. leonardite or lignite coal) contains therein graphene-like domains or aromatic molecules that span from 5 nm to 1 μm in length or width. These graphene-like domains contain planes of hexagonal carbon atoms and/or hexagonal carbon atomic interlayers with an interlayer spacing. These graphene-like planes or molecules or interlayers are typically interconnected with disordered chemical groups containing typically C, O, N, P, and/or H. The presently invented method is capable of exfoliating/separating the interlayers or separating/extracting graphene-like planes or domains from the surrounding disordered chemical species to obtain isolated graphene sheets.

Each graphene sheet comprises one or multiple planes of two-dimensional hexagonal structure of carbon atoms. Each graphene sheet has a length and a width parallel to the graphene plane and a thickness orthogonal to the graphene plane. By definition, the thickness of an NGP is 100 nanometers (nm) or smaller (more typically <10 nm and most typically and desirably <3.4 nm (<10 layers or 10 graphene planes), with a single-sheet NGP (single-layer graphene) being as thin as 0.34 nm. The length and width of a NGP are typically between 5 nm and 10 μm, but more typically from 5 nm to 500 nm for those graphene sheets derived from coal or coke. Generally, the graphene sheets produced from the coal or coke powder using the presently invented method are single-layer graphene or few-layer graphene (2-10 graphene planes stacked together).

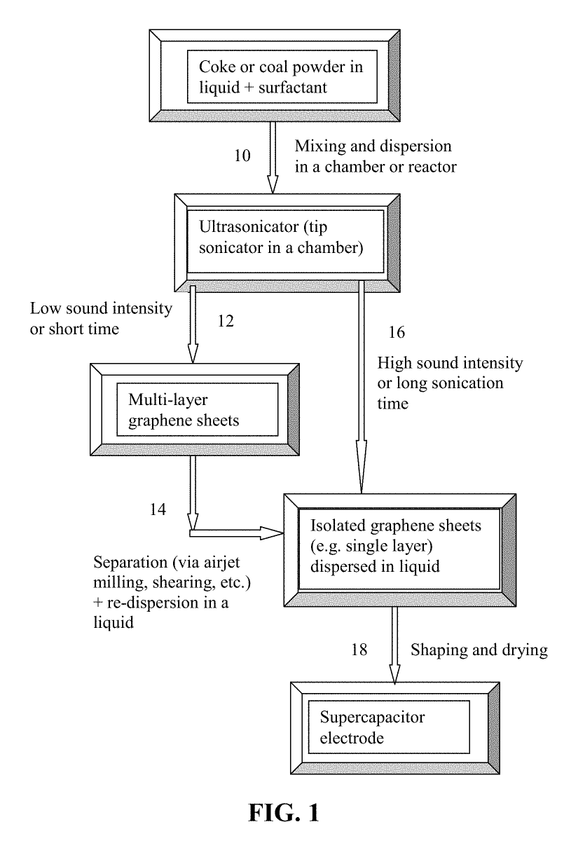

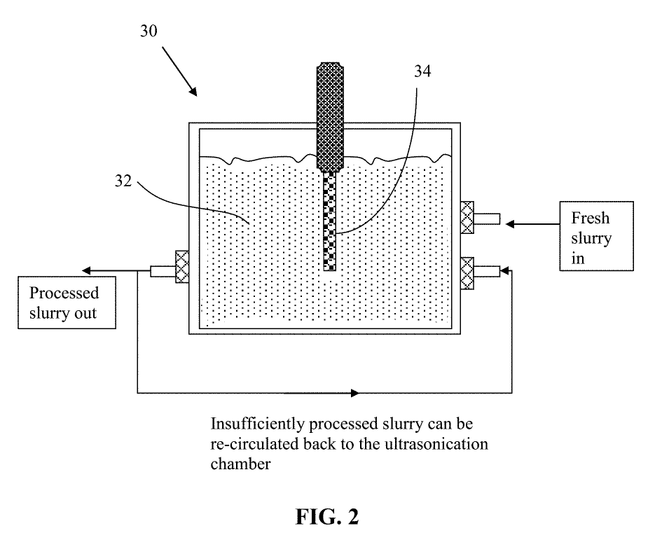

As schematically shown in FIG. 1 and FIG. 2, the presently invented process comprises three steps. Step (a) entails dispersing particles of a coke or coal powder in a liquid medium containing therein an optional surfactant or dispersing agent to produce a suspension or slurry (32 in FIG. 2). This step (10 in FIG. 1) can include filling coke/coal powder and the liquid medium (with or without a surfactant) into a chamber or reactor 30, which contains an ultrasonicator tip 34. Multiple tips can be implemented in a reactor if deemed necessary. The coke or coal powder may be selected from petroleum coke, coal-derived coke, meso-phase coke, synthetic coke, leonardite, anthracite, lignite coal, bituminous coal, or natural coal mineral powder, or a combination thereof.

Step (b) entails exposing the suspension or slurry to ultrasonication at an energy level for a sufficient length of time to produce the isolated graphene sheets. As illustrated in FIG. 1, one can choose to use low sonic wave intensity and/or shorter ultrasound exposure time (12) to produce thicker NGPs, each typically containing from 5 to 20 graphene planes. This is followed by subjecting the thick NGPs to mechanical separation treatments 14 (e.g. airjet milling, rotating-blade shearing, wet milling, etc.) to obtain thinner graphene sheets. The isolated graphene sheets are then re-dispersed in a liquid medium to make a suspension or slurry.

Alternatively, one could use higher sonic power for a longer period of time to directly produce thin graphene sheets that are dispersed in a liquid medium (16 in FIG. 1). This can be readily accomplished by continuously or intermittently pumping the slurry out of the chamber and then re-circulating back to the chamber or into a second chamber, as illustrated in FIG. 2. A cascade of ultrasonicator chambers may be connected in series.

As illustrated in the lower portion, 18, of FIG. 1, Step (c) includes shaping and drying the graphene suspension to form a supercapacitor electrode that is porous and has a specific surface area greater than 200 m²/g, preferably greater than 500 m²/g, more preferably greater than 1,000 m²/g, further preferably greater than 1,500 m²/g, and most preferably greater than 2,000 m²/g. This can be accomplished by adding a carbon precursor (e.g. a polymer) or a blowing agent into the graphene-liquid suspension after ultrasonication, followed by casting, printing, coating, fiber-spinning, or extrusion of the suspension to form a desired shape. Such a shape (layer, sheet, film, rod, filament, tube, etc.) is then thermally treated to convert the polymer into carbon or activating the blowing agent, generating pores in the shape (essentially a foaming procedure. Alternatively, the graphene-liquid suspension may be made into a shape which undergoes freeze-drying to form a porous structure.

Using needle coke as an example, the first step may involve preparing a coke powder sample containing fine needle coke particulates (needle-shaped). The length and/or diameter of these particles are preferably less than 0.2 mm (<200 μm), further preferably less than 0.01 mm (10 μm). They can be smaller than 1 μm. The needle coke particles typically contain nanometer-scaled graphite crystallites with each crystallite being composed of multiple graphene planes.

The powder is then dispersed in a liquid medium (e.g., water, alcohol, or acetone) to obtain a suspension or slurry with the particles being suspended in the liquid medium. Preferably, a dispersing agent or surfactant is used to help uniformly disperse particles in the liquid medium. Most importantly, we have surprisingly found that the dispersing agent or surfactant facilitates the exfoliation and separation of the laminar material. Under comparable processing conditions, a coke/coal sample containing a surfactant usually results in much thinner platelets compared to a sample containing no surfactant. It also takes a shorter length of time for a surfactant-containing suspension to achieve a desired platelet dimension.

Surfactants or dispersing agents that can be used include anionic surfactants, non-ionic surfactants, cationic surfactants, amphoteric surfactants, silicone surfactants, fluoro-surfactants, and polymeric surfactants. Particularly useful surfactants for practicing the present invention include DuPont's Zonyl series that entails anionic, cationic, non-ionic, and fluoro-based species. Other useful dispersing agents include sodium hexametaphosphate, sodium lignosulphonate (e.g., marketed under the trade names Vanisperse CB and Marasperse CBOS-4 from Borregaard LignoTech), sodium sulfate, sodium phosphate, and sodium sulfonate.

Advantageously, the surfactant or dispersing agent may be selected from melamine, ammonium sulfate, sodium dodecyl sulfate, sodium (ethylenediamine), tetraalkyammonium, ammonia, carbamide, hexamethylenetetramine, organic amine, pyrene, 1-pyrenecarboxylic acid, 1-pyrenebutyric acid, 1-pyrenamine, poly(sodium-4-styrene sulfonate), or a combination thereof

It may be noted that the formation of graphite intercalation compound (GICs) involves the use of highly oxidizing agents (e.g. nitric acid or potassium permanganate), which causes severe oxidation to graphite. Upon oxidation, graphite would suffer from a dramatic loss in electrical and thermal conductivity and this normally cannot be fully recovered.

In contrast, the presently invented method makes use of an ultrasonication temperature typically lying between 0° C. and 100° C. and only very mild liquid mediums are used (water, alcohol, etc.). Hence, this method obviates the need or possibility to expose the layered coke/coal material to an oxidizing environment. If so desired, the product after ultrasonication may be subjected to a subsequent mechanical shearing treatment, such as ball milling, air milling, or rotating-blade shearing, at a relatively low temperature (e.g., room temperature). With this treatment, either individual graphene planes or stacks of graphene planes bonded together (multi-layer NGPs) are further reduced in thickness (decreasing number of layers), width, and length. In addition to the thickness dimension being nano-scaled, both the length and width of these NGPs could be reduced to smaller than 100 nm in size if so desired.

In the thickness direction (or c-axis direction normal to the graphene plane), there may be a small number of graphene planes that are still bonded together through the van der Waal's forces that commonly hold the basal planes together. Typically, there are less than 15 layers (often less than 5 layers) of graphene planes. High-energy planetary ball mills and rotating blade shearing devices were found to be particularly effective in producing thinner sheets. Since ball milling and rotating-blade shearing are considered as mass production processes, the presently invented method is capable of producing large quantities of graphene materials cost-effectively. This is in sharp contrast to the production and purification processes of carbon nano-tubes, which are slow and expensive.

The exfoliation step in the instant invention does not involve the evolution of undesirable species, such as NOₓ and SOₓ, which are common by-products of exfoliating conventional sulfuric or nitric acid-intercalated graphite compounds. These chemical species are highly regulated worldwide.

Ultrasonic energy also enables the resulting graphene sheets to be well dispersed in the very liquid medium wherein the coke/coal powder is dispersed, producing a homogeneous suspension. One major advantage of this approach is that exfoliation, separation, and dispersion of graphene sheets are achieved in a single step. A monomer, oligomer, or polymer may be added to this suspension to form a suspension that is a precursor to a nanocomposite structure. The process may include a further step of converting the suspension to a mat or paper (e.g., using any well-known paper-making process), or converting the nanocomposite precursor suspension to a nanocomposite solid. The polymer may then be thermally converted into a carbon binder that bonds together graphene sheets to form a porous supercapacitor electrode.

Thus, in certain embodiments, the liquid medium comprises water, organic solvent, alcohol, a monomer, an oligomer, or a combination thereof. In other embodiments, the liquid medium further comprises a monomer or an oligomer dispersed in the liquid medium and step (b) induces polymerization of the monomer or oligomer to form a polymer. The graphene sheets concurrently produced can be well-dispersed in the polymer. This added advantage is also unexpected.

In some embodiments of the invention, the liquid medium further comprises a polymer dissolved or dispersed in the liquid medium and the isolated graphene sheets are mixed with the polymer to form a composite composition. This is a good approach to the preparation of graphene-reinforced polymer composites, which can be thermally converted to porous composite structure having graphene sheets bonded by a carbon binder.

Alternatively, the resulting graphene sheets, after drying to become a solid powder, may be mixed with a monomer to form a mixture, which can be polymerized to obtain a nanocomposite solid. The graphene sheets can be mixed with a polymer melt to form a mixture that is subsequently solidified to become a nanocomposite solid, which can be thermally converted to porous composite structure having graphene sheets bonded by a carbon binder.

Again, the wetting agent may be selected from melamine, ammonium sulfate, sodium dodecyl sulfate, sodium (ethylenediamine), tetraalkyammonium, ammonia, carbamide, hexamethylenetetramine, organic amine, poly(sodium-4-styrene sulfonate), or a combination thereof. We have surprisingly observed several advantages that can be achieved by adding a wetting agent in the electrolyte, in addition to an intercalating agent. Typically, the addition of a wetting agent to the liquid medium leads to thinner graphene sheets as compared to the liquid medium containing no wetting agent. This is reflected by the typically larger specific surface areas per unit mass of graphene sheets produced after exfoliation as measured by the well-known BET method. It seems that the wetting agent can readily spread into inter-layer spaces, stick to a graphene plane, and prevent graphene sheets, once formed, from being re-stacked together. This is a particularly desirable feature considering the fact that graphene planes, when separated, have a great tendency to re-stack again. The presence of these graphene plane wetting agents serves to prevent re-stacking of graphene sheets.

In the presently invented process, step (c) may include depositing graphene suspension onto a surface of a solid substrate to form a wet graphene layer (e.g. a film) under the influence of a shear stress or compressive stress to align the graphene sheets parallel to the substrate surface, and wherein the wet film is heated and dried to form a porous dry graphene film. The graphene suspension may be deposited onto the surface using a procedure of casting, coating, spraying, printing, fiber-spinning, extrusion, or a combination thereof. The wet graphene film or dry graphene film (containing volatile species, foaming agent, or precursor polymer, etc.) may be subjected to a heat treatment at a temperature from 100° C. to 3,200° C. to activate the evolution of gaseous species that lead to the formation of pores in the resulting graphene structure.

The step of shaping and drying the graphene suspension may comprise dispensing the suspension onto a surface or two surfaces of a current collector (e.g. Al foil) to form the desired supercapacitor electrode in a film form having a thickness from 1 μm to 1,000 μm.

Alternatively, the step of shaping and drying the graphene suspension comprises dispensing and heat treating the suspension to form a layer of graphene foam having a thickness from 1 μm to 1,000 μm. A blowing agent or foaming agent may be used.

In the field of plastic processing, chemical blowing agents are mixed into the plastic pellets in the form of powder or pellets and dissolved at higher temperatures. Above a certain temperature specific for blowing agent dissolution, a gaseous reaction product (usually nitrogen or CO₂) is generated, which acts as a blowing agent. However, a chemical blowing agent cannot be dissolved in a graphene material, which is a solid, not liquid. This presents a challenge to make use of a chemical blowing agent to generate pores or cells in a graphene material.

After extensive experimenting, we have discovered that practically any chemical blowing agent (e.g. in a powder or pellet form) can be used to create pores or bubbles in a dried layer of graphene when the first heat treatment temperature is sufficient to activate the blowing reaction. The chemical blowing agent (powder or pellets) may be dispersed in the liquid medium to become a second dispersed phase (sheets of graphene material being the first dispersed phase) in the suspension, which can be deposited onto the solid supporting substrate to form a wet layer. This wet layer of graphene material may then be dried and heat treated to activate the chemical blowing agent. After a chemical blowing agent is activated and bubbles are generated, the resulting foamed graphene structure is largely maintained even when subsequently a higher heat treatment temperature is applied to the structure. This is quite unexpected, indeed.

Chemical foaming agents (CFAs) can be organic or inorganic compounds that release gasses upon thermal decomposition. CFAs are typically used to obtain medium- to high-density foams, and are often used in conjunction with physical blowing agents to obtain low-density foams. CFAs can be categorized as either endothermic or exothermic, which refers to the type of decomposition they undergo. Endothermic types absorb energy and typically release carbon dioxide and moisture upon decomposition, while the exothermic types release energy and usually generate nitrogen when decomposed. The overall gas yield and pressure of gas released by exothermic foaming agents is often higher than that of endothermic types. Endothermic CFAs are generally known to decompose in the range of 130 to 230° C. (266-446° F.), while some of the more common exothermic foaming agents decompose around 200° C. (392° F.). However, the decomposition range of most exothermic CFAs can be reduced by addition of certain compounds. The activation (decomposition) temperatures of CFAs fall into the range of our heat treatment temperatures. Examples of suitable chemical blowing agents include sodium bi-carbonate (baking soda), hydrazine, hydrazide, azodicarbonamide (exothermic chemical blowing agents), nitroso compounds (e.g. N, N-Dinitroso pentamethylene tetramine), hydrazine derivatives (e.g. 4. 4′-Oxybis (benzenesulfonyl hydrazide) and Hydrazo dicarbonamide), and hydrogen carbonate (e.g. Sodium hydrogen carbonate). These are all commercially available in plastics industry.

In the production of foamed plastics, physical blowing agents are metered into the plastic melt during foam extrusion or injection molded foaming, or supplied to one of the precursor materials during polyurethane foaming. It has not been previously known that a physical blowing agent can be used to create pores in a graphene material, which is in a solid state (not melt). We have surprisingly observed that a physical blowing agent (e.g. CO₂ or N₂) can be injected into the stream of graphene suspension prior to being coated or cast onto the supporting substrate. This would result in a foamed structure even when the liquid medium (e.g. water and/or alcohol) is removed. The dried layer of graphene material is capable of maintaining a controlled amount of pores or bubbles during liquid removal and subsequent heat treatments.

Technically feasible blowing agents include Carbon dioxide (CO₂), Nitrogen (N₂), Isobutane (C₄H₁₀), Cyclopentane (C₅H₁₀), Isopentane (C₅H₁₂), CFC-11 (CFCI₃), HCFC-22 (CHF₂CI), HCFC-142b (CF₂CICH₃), and HCFC-134a (CH₂FCF₃). However, in selecting a blowing agent, environmental safety is a major factor to consider. The Montreal Protocol and its influence on consequential agreements pose a great challenge for the producers of foam. Despite the effective properties and easy handling of the formerly applied chlorofluorocarbons, there was a worldwide agreement to ban these because of their ozone depletion potential (ODP). Partially halogenated chlorofluorocarbons are also not environmentally safe and therefore already forbidden in many countries. The alternatives are hydrocarbons, such as isobutane and pentane, and the gases such as CO₂ and nitrogen.

Except for those regulated substances, all the blowing agents recited above have been tested in our experiments. For both physical blowing agents and chemical blowing agents, the blowing agent amount introduced into the suspension is defined as a blowing agent-to-graphene material weight ratio, which is typically from 0/1.0 to 1.0/1.0.

Advantageously, the step of shaping and drying the graphene suspension comprises forming the suspension into a desired shape (with desired dimensions) and freeze-drying the suspension to form a graphene foam electrode.

The following examples serve to provide the best modes of practice for the present invention and should not be construed as limiting the scope of the invention:

### Example 1: Production of Graphene-Based Supercapacitor Electrodes from Milled Coal-Derived Needle Coke Powder

Needle coke, milled to an average length <10 μm, was used as the starting material. Five grams of needle coke powder were dispersed in 1,000 mL of deionized water (containing 0.1% by weight of a dispersing agent, Zonyl® FSO from DuPont) to obtain a suspension. An ultrasonic energy level of 85 W (Branson 5450 Ultrasonicator) was used for exfoliation, separation, and size reduction of needle coke particles for a period of 2 hours. Various samples were collected with their morphology studied by SEM, TEM, and AFM observations and their specific surface areas measured by the well-known BET method. The specific surface area of the produced graphene sheets are typically in the range of 840-950 m²/g, indicating that a majority of the graphene sheets being single-layer graphene, consistent with the microscopy results.

For the preparation of supercapacitor electrodes, various amounts (1%-30% by weight relative to graphene material) of chemical bowing agents (N,N-Dinitroso pentamethylene tetramine or 4. 4′-Oxybis (benzenesulfonyl hydrazide) were added to a suspension containing pristine graphene sheets and a surfactant. The suspension was then cast onto a glass surface using a doctor's blade to exert shear stresses, inducing graphene sheet orientations. Several samples were cast, including one that was made using CO₂ as a physical blowing agent introduced into the suspension just prior to casting). The resulting graphene films, after removal of liquid, have a thickness that can be varied from approximately 10 to 500 μm.

The graphene films were then subjected to heat treatments that involve a thermal reduction temperature of 180-250° C. for 1-5 hours. This heat treatment generated a graphene foam.

In addition, some amounts of the graphene sheets suspended in the suspension were made into a sheet of graphene paper using the well-known vacuum-assisted filtration procedure.

### Comparative Example 1: Concentrated Sulfuric-Nitric Acid-Intercalated Needle Coke Particles

One gram of milled needle coke powder as used in Example 1 were intercalated with a mixture of sulfuric acid, nitric acid, and potassium permanganate at a weight ratio of 4:1:0.05 (graphite-to-intercalate ratio of 1:3) for four hours. Upon completion of the intercalation reaction, the mixture was poured into deionized water and filtered. The sample was then washed with 5% HCl solution to remove most of the sulfate ions and residual salt and then repeatedly rinsed with deionized water until the pH of the filtrate was approximately 5. The dried sample was then exfoliated at 1,000° C. for 45 seconds. The resulting NGPs were examined using SEM and TEM and their length (largest lateral dimension) and thickness were measured. It was observed that, in comparison with the conventional strong acid process for producing graphene, the presently invented electrochemical intercalation method leads to graphene sheets of comparable thickness distribution, but much larger lateral dimensions (3-5 μm vs. 200-300 nm). Graphene sheets were made into graphene paper layer using a well-known vacuum-assisted filtration procedure. The graphene paper prepared from hydrazine-reduced graphene oxide (made from sulfuric-nitric acid-intercalated coke) exhibits electrical conductivity values of 11-143 S/cm. The graphene paper prepared from the relatively oxidation-free graphene sheets made by the presently invented ultrasonication approach exhibit conductivity values of 1,600-3,720 S/cm.

### Example 2: Production of Graphene-Based Electrodes from Milled Coal-Derived Needle Coke Powder (No Dispersing Agent)

Five grams of needle coke from the same batch as used in Example 1 were dispersed in 1,000 mL of deionized water to obtain a suspension. An ultrasonic energy level of 85 W (Branson 5450 Ultrasonicator) was used for exfoliation, separation, and size reduction for a period of 2 hours. Various samples were collected with their morphology studied by SEM and TEM observations and their specific surface areas measured by the well-known BET method. The specific surface area of the produced graphene sheets are typically in the range of 240-450 m²/g (mostly few-layer graphene). Certain amounts of the sample containing mostly multi-layer graphene sheets were then subjected to ultrasonication again to produce ultra-thin graphene sheets. Electron microscopic examinations of selected samples indicate that the majority of the resulting NGPs are single-layer graphene sheets.

A small amount of single-layer graphene sheets were then re-dispersed in a hydrogen peroxide-water solution (30% H₂O₂) for 24 hours to prepare graphene oxide sheets. These graphene oxide sheets were then mixed with the original pristine single-layer graphene sheets at a weight ratio of 1:3 in the original suspension after ultrasonication.

The mixture suspension was then cast onto a glass surface using a doctor's blade to exert shear stresses, inducing graphene sheet orientations. The resulting graphene films, after removal of liquid, have a thickness of 200 μm. The graphene films were then subjected to heat treatments that involve a thermal reduction temperature of 80-1,500° C. for 1-5 hours. This heat treatment generated a layer of graphene foam as a supercapacitor electrode.

### Example 3: Production of Graphene-Based Electrodes from Milled Petroleum Needle Coke Powder

Needle coke, milled to an average length <10 μm, was used as the starting material and was dispersed in 1,000 mL of DI water. The dispersing agents selected include melamine, sodium (ethylenediamine), and hexamethylenetetramine. An ultrasonic energy level of 125 W (Branson 5450 Ultrasonicator) was used for exfoliation, separation, and size reduction for a period of 1 hour. The specific surface area of the produced graphene sheets are typically in the range of 740-880 m²/g (mostly single-layer graphene). Melamine appears to be the most effective dispersing agent, leading to the highest specific surface areas of graphene sheets. Products containing a majority of graphene sheets being single-layer graphene can be readily produced using the presently invented direct ultrasonication method.

The mixture was then sprayed onto a glass surface and the resulting graphene films, after removal of liquid, have a thickness of 150-1,200 μm. The graphene films were then subjected to heat treatments that involve a thermal decomposition temperature of 450° C. for 3 hours to remove melamine-derived volatile species. This treatment generated a layer of graphene foam as a supercapacitor electrode. The typical thickness is from 200 to 2,000 μm; there is no upper limit on the thickness of the supercapacitor electrodes prepared according to the instant process. The achievable active mass loading is typically from 15 to 150 mg/cm². This is quite unexpected since the conventional slurry coating process has been incapable of coating a graphene-based supercapacitor electrode having a thickness above 150 μm or an active material loading above 10 mg/cm².

### Example 4: Production of Graphene-Based Electrodes from Milled Lignite Coal Powder

In one example, samples of two grams each of lignite coal were milled down to an average diameter of 25.6 μm. The powder samples were subjected to similar direct ultrasonication conditions described in Example 1. After a mechanical shearing treatment in a high-shear rotating blade device for 15 minutes, the resulting graphene sheets exhibit a thickness ranging from single-layer graphene sheets to 8-layer graphene sheets based on SEM and TEM observations. A small amount of polyethylene oxide (PEO/graphene ratio=0.05 by weight) was added into the water suspension containing graphene sheets after mechanical shearing. The suspension was extruded into filaments that are 1 mm in diameters, which were heated at 450° C. for 3 hours to produce filamentary electrodes. The filament diameters can be as small as 50 nm if electro-spinning is used to produce nano-fibers.

### Example 5: Direct Ultrasonic Production of Graphene-Based Supercapacitor Electrodes from Anthracite Coal

Taixi coal from Shanxi, China was used as the starting material for the preparation of isolated graphene sheets. The raw coal was ground and sieved to a powder with an average particle size less than 200 μm. The coal powder was further size-reduced for 2.5 h by ball milling. The diameter of more than 90% of milled powder particles is less than 15 μm after milling. The raw coal powder was treated with hydrochloride in a beaker at 50° C. for 4 h to make modified coal (MC), and then it was washed with distilled water until no was detected in the filtrate. The modified coal was heat treated in the presence of Fe to transform coal into graphite-like carbon. The MC powder and Fe₂(SO4)₃ [TX-de:Fe₂(SO4)₃=16:12.6] was well-mixed by ball milling for 2 min, and then the mixture was subjected to catalytic graphitization at 2400° C. for 2 h under argon.

The coal-derived powder samples were subjected to ultrasonication under conditions that are comparable to those used in Example 1. The resulting graphene sheets exhibit a thickness ranging from single-layer graphene sheets to 5-layer graphene sheets based on SEM and TEM observations. Isolated graphene sheets were re-dispersed in water, along with some 10% by weight of sodium bi-carbonate (baking soda). The resulting suspension was then coated onto a sheet of PET film to form a wet layer, which was dried and peeled off from the PET film. The dried graphene/sodium bi-carbonate layer was then heated to 185° C. to produce a porous graphene electrode layer.

### Example 6: Production of Isolated Graphene Sheets and Graphene-Based Supercapacitor Electrodes from Bituminous Coal

In an example, 300 mg of bituminous coal was dispersed in a mixture of water-alcohol (1 L), which was then subjected to an ultrasonication treatment at a power level of 145 watts for 1 h. The solution was cooled to room temperature and poured into a beaker containing 100 ml ice. After purification, the solution was cast onto glass surface to form a layer of humic acid sheets (graphene-like 2D material).

### Example 7: Details about Evaluation of Various Supercapacitor Cells

In most of the examples investigated, both the inventive supercapacitor cells and their conventional counterparts were fabricated and evaluated. The latter cells, for comparison purposes, were prepared by the conventional procedures of slurry coating of electrodes, drying of electrodes, assembling of anode layer, separator, and cathode layer, packaging of assembled laminate, and injection of liquid electrolyte. In a conventional cell, an electrode (cathode or anode), is typically composed of 85% an electrode active material (e.g. graphene, activated carbon, inorganic nano discs, etc.), 5% Super-P (acetylene black-based conductive additive), and 10% PTFE, which were mixed and coated on Al foil. The thickness of electrode is around 100 μm. For each sample, both coin-size and pouch cells were assembled in a glove box. The capacity was measured with galvanostatic experiments using an Arbin SCTS electrochemical testing instrument. Cyclic voltammetry (CV) and electrochemical impedance spectroscopy (EIS) were conducted on an electrochemical workstation (CHI 660 System, USA).

Galvanostatic charge/discharge tests were conducted on the samples to evaluate the electrochemical performance. For the galvanostatic tests, the specific capacity (q) is calculated as

q=I*t/m (1)

where I is the constant current in mA, t is the time in hours, and m is the cathode active material mass in grams. With voltage V, the specific energy (E) is calculated as,

E=∫Vdq (2)

The specific power (P) can be calculated as

P=(E/t)(W/kg) (3)

where t is the total charge or discharge step time in hours.
The specific capacitance (C) of the cell is represented by the slope at each point of the voltage vs. specific capacity plot,

C=dq/dV (4)

For each sample, several current density (representing charge/discharge rates) were imposed to determine the electrochemical responses, allowing for calculations of energy density and power density values required of the construction of a Ragone plot (power density vs. energy density).

### Example 8: Achievable Tap Density of the Electrode and its Effect on Electrochemical Performance of Supercapacitor Cells

The presently invented process allows us to prepare a graphene electrode of any practical tap density from 0.1 to 1.7 g/cm³. It may be noted that the graphene-based supercapacitor electrodes prepared by conventional processes are limited to <0.3 and mostly <0.2 g/cm³. Furthermore, as discussed earlier, only thinner electrodes can be prepared using these conventional processes. As a point of reference, the activated carbon-based electrode exhibits a tap density typically from 0.3 to 0.5 g/cm³.

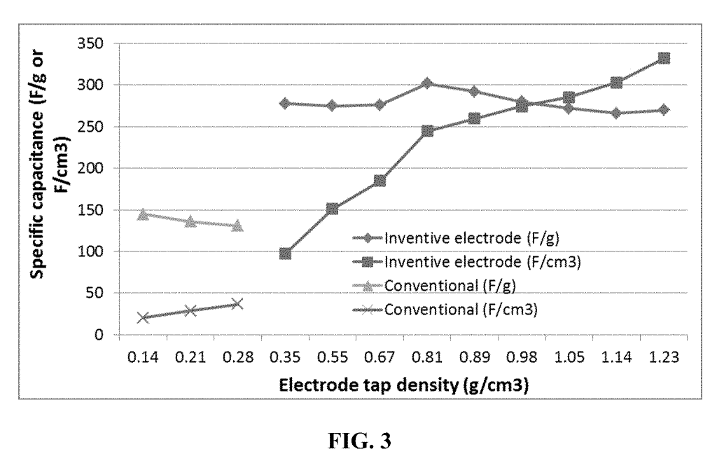

A series of EDLC electrodes with different tap densities were prepared from the same batch of graphene suspension. The volume and weights of an electrode were measured before and after foaming and before and after roll-pressing. These measurements enabled us to estimate the tap density of the dried electrode. For comparison purposes, graphene-based electrodes of comparable thickness (70-75 μm) were also prepared using the conventional slurry coating process (the wet-dry-wet procedures). The electrode specific capacitance values of these supercapacitors using an organic electrolyte (acetonitrile) are summarized in FIG. 3. There are several significant observations that can be made from these data:
(A) Given comparable electrode thickness, the presently invented graphene supercapacitors exhibit significantly higher gravimetric specific capacitance (266-302 F/g) as compared to those (130-150 F/g) of the corresponding graphene-based electrodes prepared by the conventional process, all based on EDLC alone.
(B) The highest achievable tap density of the electrode prepared by the conventional method is 0.14-0.28 g/cm³. In contrast, the presently invented process makes it possible to achieve a tap density of 0.35-1.23 g/cm³ (based on this series of samples alone); these unprecedented values even surpass those (0.3-0.5 g/cm³) of activated carbon electrodes by a large margin.
(C) The presently invented graphene electrodes exhibit a volumetric specific capacitance up to 332 F/cm³, which is also an unprecedented value. In contrast, the graphene electrodes prepared according to the conventional method shows a specific capacitance in the range of 21-40 F/cm³; the differences are dramatic.

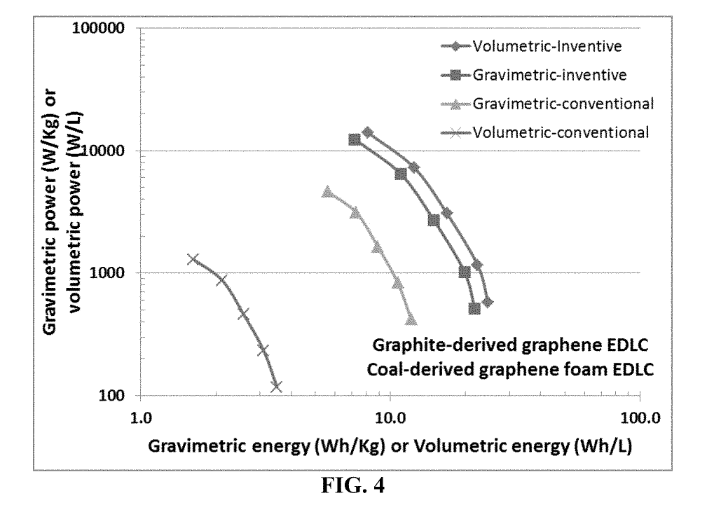

Shown in FIG. 4 are Ragone plots (gravimetric and volumetric power density vs. energy density) of two sets of symmetric supercapacitor (EDLC) cells containing graphene sheets as the electrode active material and EMIMBF4 ionic liquid as the electrolyte. One of the two series of supercapacitors was based on the graphene electrode (coke-derived graphene) prepared according to an embodiment of instant invention and the other was by the conventional slurry coating of electrodes (natural graphite-derived graphene sheets). Several significant observations can be made from these data:
(A) Both the gravimetric and volumetric energy densities and power densities of the supercapacitor cells prepared by the presently invented method (denoted as “inventive” in the figure legend) are significantly higher than those of their counterparts prepared via the conventional method (denoted as “conventional”). The differences are highly dramatic and are mainly due to the high active material mass loading (>20 mg/cm²) associated with the presently invented cells, reduced proportion of overhead components (non-active) relative to the active material weight/volume, no binder resin, the ability of the inventive method to more effectively pack graphene sheets together without graphene sheet re-stacking.
(B) For the cells prepared by the conventional method, the absolute magnitudes of the volumetric energy densities and volumetric power densities are significantly lower than those of their gravimetric energy densities and gravimetric power densities, due to the very low tap density (packing density of 0.29 g/cm³) of isolated graphene sheet-based electrodes prepared by the conventional slurry coating method.
(C) In contrast, for the cells prepared by the presently invented method, the absolute magnitudes of the volumetric energy densities and volumetric power densities are higher than those of their gravimetric energy densities and gravimetric power densities, due to the relatively high tap density (packing density of 1.13 g/cm³) of graphene-based electrodes prepared by the presently invented method.

1. A process for producing a graphene-based supercapacitor electrode from a supply of coke or coal powder containing therein domains of hexagonal carbon atoms and/or hexagonal carbon atomic interlayers with an interlayer spacing, said process comprising:
(a) dispersing particles of said coke or coal powder in a liquid medium containing therein an optional surfactant or dispersing agent to produce a suspension or slurry, wherein said coke or coal powder is selected from the group consisting of petroleum coke, coal-derived coke, meso-phase coke, synthetic coke, leonardite, anthracite, lignite coal, bituminous coal, natural coal mineral powder, and a combination thereof;
(b) exposing said suspension or slurry to ultrasonication at an energy level for a sufficient length of time to produce a graphene suspension containing isolated graphene sheets dispersed in said liquid medium; and
(c) shaping and drying said graphene suspension to form said supercapacitor electrode that is porous and has a specific surface area greater than 200 m²/g.

2. The process of claim 1 wherein said particles of said coke or coal powder have never been previously intercalated or oxidized prior to step (a).

3. The process of claim 1 wherein said supercapacitor electrode is in a paper sheet, porous film, filament, rod, or tube form.

4. The process of claim 1 wherein said liquid medium comprises water, an organic solvent, alcohol, a monomer, an oligomer, or a combination thereof.

5. The process of claim 1 wherein said liquid medium further comprises a monomer or an oligomer dispersed in said liquid medium and, in said step (b), said ultrasonication also induces polymerization of said monomer or oligomer to form a polymer.

6. The process of claim 5, further comprising a step of thermally converting said polymer into carbon or graphite that acts as a binder to bond said isolated graphene sheets together to form said supercapacitor electrode that has a specific surface area greater than 500 m²/g.

7. The process of claim 6, wherein said specific surface area is greater than 1,000 m²/g.

8. The process of claim 6, wherein said specific surface area is greater than 2,000 m²/g.

9. The process of claim 1 wherein said liquid medium further comprises a polymer dissolved or dispersed in said liquid medium and said isolated graphene sheets are mixed with said polymer to form a composite composition.

10. The process of claim 9, further comprising a step of thermally converting said polymer into carbon or graphite that acts as a binder to bond said isolated graphene sheets together to form said supercapacitor electrode that has a specific surface area greater than 500 m²/g.

11. The process of claim 10, wherein said specific surface area is greater than 1,000 m²/g

12. The process of claim 1 wherein said surfactant or dispersing agent is selected from the group consisting of anionic surfactants, nonionic surfactants, cationic surfactants, amphoteric surfactants, silicone surfactants, fluoro-surfactants, polymeric surfactants, sodium hexametaphosphate, sodium lignosulphonate, poly (sodium 4-styrene sulfonate), sodium dodecylsulfate, sodium sulfate, sodium phosphate, sodium sulfonate, and combinations thereof.

13. The process of claim 1 wherein said surfactant or dispersing agent is selected from melamine, ammonium sulfate, sodium dodecyl sulfate, sodium (ethylenediamine), tetraalkyammonium, ammonia, carbamide, hexamethylenetetramine, organic amine, pyrene, 1-pyrenecarboxylic acid, 1-pyrenebutyric acid, 1-pyrenamine, poly(sodium-4-styrene sulfonate), or a combination thereof.

14. The process of claim 1, wherein a desired amount of a foaming agent is added into said graphene suspension and said step (c) includes depositing said graphene suspension onto a surface of a solid substrate to form a wet graphene film under the influence of a shear stress or compressive stress to align said graphene sheets parallel to said substrate surface, and wherein said wet film is dried to form a porous dry graphene film.

15. The process of claim 1, wherein a desired amount of a foaming agent is added into said graphene suspension and said step (c) includes shaping the graphene suspension using a procedure of casting, coating, spraying, printing, extrusion, fiber spinning, or a combination thereof.

16. The process of claim 14, wherein said wet graphene film or dry graphene film is subjected to a heat treatment at a temperature from 100° C. to 3,200° C.

17. The process of claim 1, wherein said step of shaping and drying said graphene suspension comprises dispensing said suspension onto a surface or two surfaces of a current collector to form said electrode in a film form having a thickness from 1 μm to 1,000 μm.

18. The process of claim 5, wherein said step of shaping and drying said graphene suspension comprises dispensing said suspension onto a surface or two surfaces of a current collector to form said electrode in a film form having a thickness from 1 μm to 1,000 μm.

19. The process of claim 9, wherein said step of shaping and drying said graphene suspension comprises dispensing said suspension onto a surface or two surfaces of a current collector to form said electrode in a film form having a thickness from 1 μm to 1,000 μm.

20. The process of claim 1, wherein said step of shaping and drying said graphene suspension comprises dispensing and heat treating said suspension to form a layer of graphene foam having a thickness from 1 μm to 1,000 μm.

21. The process of claim 1, wherein said step of shaping and drying said graphene suspension comprises freeze-drying said suspension to form a graphene foam electrode.

22. The process of claim 1, wherein said electrode has an active material mass loading higher than 10 mg/cm².

23. The process of claim 1, wherein said electrode has an active material mass loading higher than 20 mg/cm².
